(19) United States
(12) Patent Application Publication
(10) Pub. No.: US 2010/0091642 A1
(43) Pub. Date: Apr. 15, 2010

(54) APPARATUS OF CELL ACQUISITION IN WIRELESS COMMUNICATION SYSTEM AND THE METHOD THEREOF

(76) Inventor: Yong-Suk Hwang, Gyeonggi-do (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/520,701

(22) PCT Filed: Dec. 26, 2007
(86) PCT No.: PCT/KR07/06827

§ 371 Date: Jun. 22, 2009

(30) Foreign Application Priority Data
Dec. 26, 2006 (KR) 10-2006-0133957

(51) Int. Cl. H04J 11/00

(52) U.S. Cl. 370/210

(57) ABSTRACT

An apparatus and a method for performing a cell search are disclosed. The apparatus includes fast Fourier transform (FFT) units converting signals received by the multiple antennas into frequency domain signals, inverse randomizers inverse-randomizing the frequency domain signals, an alignment unit aligning the inverse-randomized frequency domain signals to form an aligned signal, an inverse fast Fourier transform (IFFT) unit converting the aligned signal into a time-domain signal, a maximum value detector detecting a maximum value of the time-domain signal and a determiner determining whether a preamble is obtained based on the maximum value detected by the maximum value detector. Therefore, communication performance and quality may be improved and complexity may be reduced since one IFFT unit is used with respect to the signals received by a plurality of antennas.

### TECHNICAL FIELD

Embodiments of the present invention relate to an apparatus and a method for performing a cell search in a wireless communication system. More particularly, embodiments of the present invention relate to an apparatus and a method for performing a cell search with multiple antennas in a time-division duplex/orthogonal frequency-division multiple access (TDD/OFDMA) communication system complying with the Institute of Electrical and Electronics Engineers (IEEE) 802.16d/e standard.

### BACKGROUND ART

WiBro, which is currently a mobile Internet standard in Korea, uses an orthogonal frequency-division multiplexing (OFDM) signal transmission scheme so that a high speed data service can be provided even though a user is in motion.

The OFDM scheme is a typical multi-carrier transmission scheme in which a number of orthogonal subcarriers overlap. In the scheme, a serial symbol stream is converted into parallel streams, and each of the parallel streams are modulated and transmitted through a number of orthogonal subcarriers. Such an OFDM scheme is widely applicable to digital transmission technology, such as digital audio broadcasting (DAB), digital televisions, wireless local area networks (WLANs), etc. Further, since the OFDM scheme is robust against fading caused by multi-path propagation, an efficient platform for high speed data transmission may be provided by using the OFDM scheme.

WiBro also uses a multiple access scheme referred to as orthogonal frequency-division multiple access (OFDMA) based on the OFDM scheme so that Internet services can be provided to multiple users. WiBro may use multiple-input multiple-output (MIMO) technology defined as optional technology, which employs a plurality of antennas in a base station and a terminal, so that the Internet services are stably provided.

OFDMA divides a frequency region into a plurality of subchannels each of which includes subcarriers and a time region into a plurality of timeslots. OFDMA allocates the subchannels to users, respectively, by performing resource allocation with respect to both a frequency domain and a time domain so that the Internet services are available to a number of users with limited frequency resources.

Unlike a conventional manner using a single transmitting/receiving antenna, more than two antennas for multiple input/output are employed in the MIMO technology, thereby increasing operation speed, but increasing complexity as well. In the MIMO technology, which is a space-time processing technique for transmitting/receiving, transmission antennas transmit data different from each other in a transmitter, and a receiver uses a space-division multiplexing (SDM) technique, which extracts the transmitted data by interference cancellation and signal processing, as well as high-performance space-time channel coding to enhance a signal diversity gain.

Since such a terminal in a MIMO-TDD/OFDM system employs multiple antennas, the terminal has a problem in that the complexity of a terminal hardware configuration and signal processing increases as the number of the antennas increases.

### DISCLOSURE OF THE INVENTION

### Technical Problem

To obviate one or more problems due to limitations and disadvantages of the related art, an object of the present invention is to provide an apparatus and a method for performing a cell search capable of reducing the complexity of terminal hardware and signal processing by improving a cell search algorithm in a communication terminal having multiple antennas.

Another object of the present invention is to provide an apparatus and a method for performing a cell search capable of reducing the complexity of inverse fast Fourier transform (IFFT) processing with respect to signals received by a plurality of antennas.

Still another object of the present invention is to provide an apparatus and a method for performing a cell search capable of improving reception performance by combining IFFT outputs with respect to signals received by a plurality of antennas.

### Technical Solution

According to one aspect of the present invention, there is provided an apparatus for performing a cell search in a wireless communication terminal device employing a multiple antenna and multiple access scheme including a plurality of fast Fourier transform (FFT) units, a plurality of inverse randomizers, an alignment unit, an IFFT unit, a maximum value detector and a determiner. The plurality of the FFT units convert a plurality of signals respectively received by the multiple antennas into a plurality of frequency domain signals by FFT. The plurality of the inverse randomizers inverse-randomize the plurality of the frequency domain signals generated by the plurality of the FFT units, respectively. The alignment unit aligns the plurality of the inverse-randomized frequency domain signals to form an aligned signal. The IFFT unit converts the aligned signal into a time-domain signal by IFFT. The maximum value detector detects a maximum value of the time-domain signal. The determiner determines whether a preamble is obtained based on the maximum value detected by the maximum value detector.

The apparatus for performing a cell search according to some example embodiments of the present invention may be employed in a wireless communication terminal device employing multiple antennas and complying with the Institute of Electrical and Electronics Engineers (IEEE) 802.16d/e standard. For example, the apparatus for performing a cell search may be employed in a terminal device in a WiBro system or a WiMAX system.

In some embodiments, the alignment unit may include a delay unit configured to delay at least one of the plurality of the inverse-randomized frequency domain signals by a predetermined sample in order, and an adder configured to add the at least one of the plurality of the inverse-randomized frequency domain signals that have been successively delayed to another inverse-randomized frequency domain signal of the plurality of the inverse-randomized frequency domain signals and configured to output an addition result as the aligned signal.

According to one aspect of the present invention, there is provided a method for performing a cell search in a wireless communication terminal device employing multiple antennas and a multiple access scheme. In the method for performing a cell search, a plurality of signals respectively received by the multiple antennas is converted into a plurality of frequency domain signals by FFT, and the plurality of the frequency domain signals is inverse-randomized. The plurality of the inverse-randomized frequency domain signals is aligned. The aligned signal is converted into a time-domain signal by IFFT. A maximum value of the time-domain signal is detected, and then whether a preamble is obtained is determined based on the detected maximum value.

According to one aspect of the present invention, there is provided a method for performing a cell search in a wireless communication terminal. In the method for performing a cell search, a first frequency domain signal is generated by fast-Fourier-transforming a signal received by a first antenna, and a second frequency domain signal is generated by fast-Fourier-transforming a signal received by a second antenna. The first and the second frequency domain signals are inverse-randomized and aligned such that subcarriers with signals of the second frequency domain signal are located at locations of subcarriers without signals of the first frequency domain signal. A time-domain signal is generated by inverse-fast-Fourier-transforming the aligned signal, and then a preamble index is determined in response to a maximum value of the time-domain signal.

According to one aspect of the present invention, there is provided a method for performing a cell search in a wireless communication terminal. In the method for performing a cell search, signals received by first and second antennas are multiplexed in response to an antenna selection signal, and a frequency domain signal is generated by fast-Fourier-transforming the multiplexed signal. The frequency domain signal is inverse-randomized. De-multiplexed signals are stored by de-multiplexing the inverse-randomized frequency domain signal in response to the antenna selection signal. An aligned signal where subcarriers with signals of at least one of the stored de-multiplexed signals are located at locations of subcarriers without signals of another stored de-multiplexed signal of the stored de-multiplexed signals is output. A time-domain signal is generated by inverse-fast-Fourier-transforming the aligned signal, and thus a preamble index is determined in response to a maximum value of the time-domain signal.

### BRIEF DESCRIPTION OF THE DRAWINGS

The above and other advantages of the present invention will become more apparent by describing in detail example embodiments thereof with reference to the accompanying drawings, in which:

FIG. 1 is a block diagram illustrating a multiple-input multiple-output (MIMO)-time-division duplex/orthogonal frequency-division multiple access (TDD/OFDMA) wireless communication system;

FIG. 2 is a diagram illustrating a configuration of a TDD/OFDMA frame complying with the 802.16d/e standard;

FIG. 3 is a diagram illustrating segments 0 to 2 to which subcarriers are allocated;

FIG. 4 is a graph illustrating peak values of a time-domain signal when a preamble of a segment 0 is converted into the time-domain signal after the preamble is inverse-randomized into a preamble pilot;

FIG. 5 is a graph illustrating peak values of a combined time-domain signal in which a segment 0 and a segment 1 are combined according to an example of the present invention;

FIG. 6 is a block diagram illustrating an apparatus for performing a cell search according to an example embodiment of the present invention;

FIG. 7 is a diagram for describing alignment of frequency domain signals received by two antennas in an alignment unit illustrated in FIG. 7; and

FIG. 8 is a block diagram illustrating an apparatus for performing a cell search according to another example embodiment of the present invention.

### BEST MODE FOR CARRYING OUT THE INVENTION

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

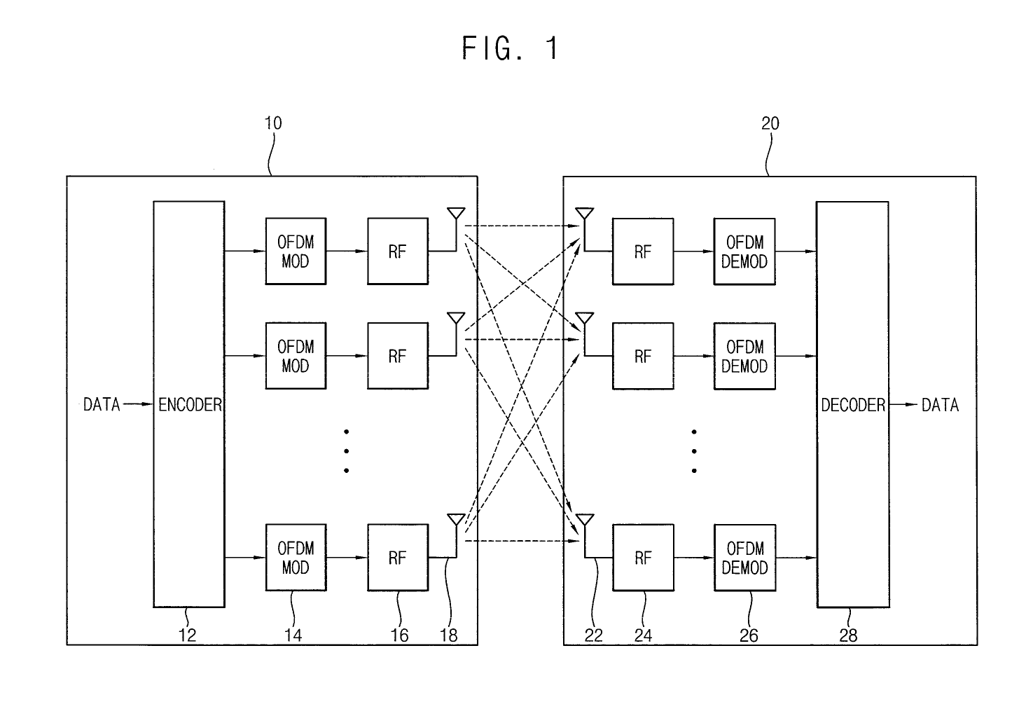

FIG. 1 is a block diagram illustrating a multiple-input multiple-output

(MIMO)-time-division duplex/orthogonal frequency-division multiple access (TDD/OFDMA) wireless communication system.

A base station (BS) 10 and a mobile station (MS) 20 communicate with each other through multiple antennas. The BS 10 includes an encoder 12, a plurality of orthogonal frequency-division multiplexing (OFDM) modulators 14, a plurality of radio frequency transmitters 16 and a plurality of transmission antennas 18. The MS 20 includes a plurality of reception antennas 22, a plurality of reception antennas 24, a plurality of OFDM demodulators 26, and a decoder 28.

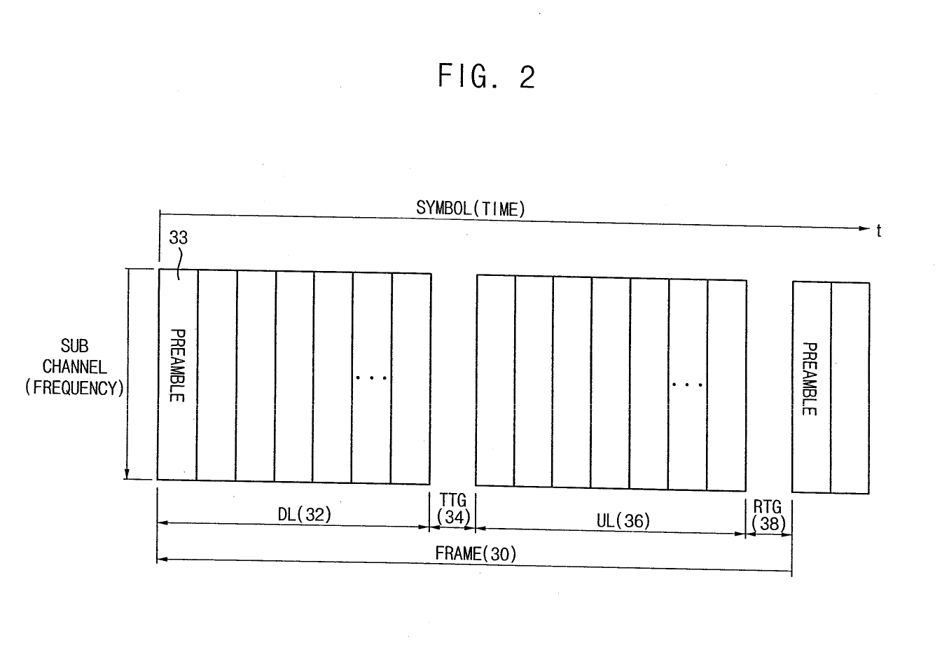

FIG. 2 is a diagram illustrating a configuration of a TDD/OFDMA frame. In FIG. 2, a horizontal axis, or a time axis, represents OFDMA symbol numbers, and a vertical axis, or a frequency axis, represents subchannel numbers. The frame 30 is configured in a TDD manner where a downlink subframe 32 and an uplink subframe 36 are divided by time. In a transition period from the downlink subframe 32 to the uplink subframe 36, a transmission transition gap (TTG) 34 exists, which is a guard time for defining a cell boundary. In a transition period from the uplink subframe 36 to the downlink subframe 32, a reception transition gap (RTG) 38 exists, which is a guard time for switching.

The downlink subframe 32 may include a preamble, a map, a channel for common control and calling, and a subchannel with a pilot for the channel estimation. The uplink subframe 36 also may include various channels.

The downlink subframe 32 includes a preamble 33. Signals transmitted from each BS have preambles different from each other according to frames. A MS must extract a preamble that indicates a start of a frame, and identify the extracted preamble among a number of preambles. The MS receives preambles transmitted from a number of BSs through a downlink and performs an initial cell search.

Through the cell search, the MS may find a current BS to which the MS belongs, a sector, or a segment, and may form a link for a service. In a WiBro system, each BS generates a preamble with unique ID cell information and segment information, and thus the MS may identify the current BS based on the ID cell information and the segment information.

The preamble may be used not only for an initial synchronization and cell search, but also for frequency offset and channel estimation. Each BS may select a pseudorandom noise (PN) sequence among PN sequences provided by a standard based on the ID cell information and the segment information. The PN sequence is modulated by boosted binary phase-shift keying (BPSK). The modulated PN sequence is allocated to a subcarrier located at an appropriate position based on PreambleCarrierSetn information.

In some embodiments, a preamble is defined as below when a 1,024 point fast Fourier transform (FFT) is used.

There may be 114 PN sequences used as preambles. Each PN sequence consists of 284 bits. The 284 bits are allocated to subcarriers in a frequency domain by a manner described below to generate a preamble symbol.

The preamble symbol uses 852 subcarriers except for 172 subcarriers (i.e., left and right guard subcarriers and DC subcarriers) among 1,024 subcarriers. One carrier set of three carrier sets may be used to generate the preamble symbol. A carrier set is defined as follows:

PreambleCarrierSetn=n+3 k [Expression 1]

Here, PreambleCarrierSetn represents all subcarriers allocated to a specific preamble, n represents an index of a preamble subcarrier set, which may be 0, 1, or 2, and k represents a running index allocated to each set, which may be a number ranging from 0 to 283.

A segment number is assigned to each preamble, and a carrier set is assigned to a segment as follows:

Segment 0 uses preamble carrier-set 0

Segment 1 uses preamble carrier-set 1

Segment 2 uses preamble carrier-set 2

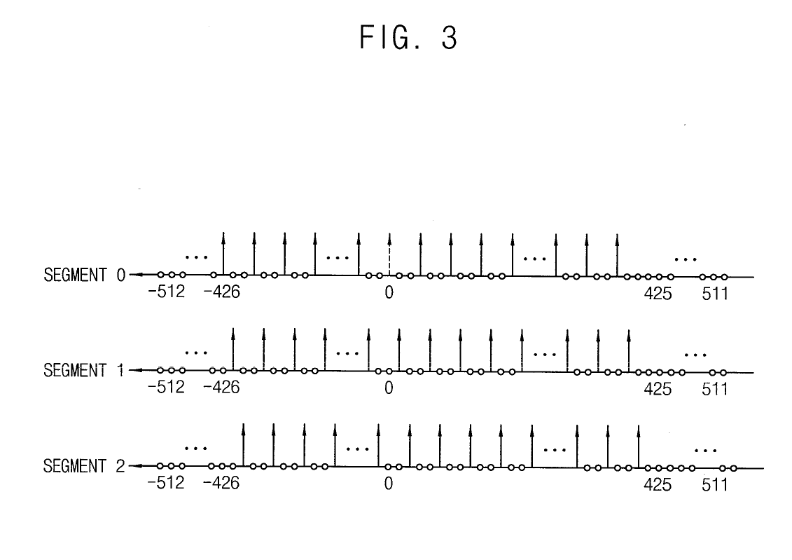

FIG. 3 is a diagram illustrating segments 0 to 2 to which subcarriers are allocated. In FIG. 3, since a subcarrier located at position “0” in a subcarrier set of a segment 0 has no direct current (DC) component, the subcarrier may be zero even though a preamble subcarrier is allocated. In the segment 0 illustrated in FIG. 3, 284 bits are respectively mapped to subcarriers having a subcarrier index of which a remainder is 0 when the subcarrier index is divided by 3, which are allocated as subcarriers with signals. The other subcarriers are allocated as subcarriers without signals to which elements of the preamble are not mapped.

As a similar manner, in a segment 1, 284 bits are respectively mapped to subcarriers having a subcarrier index of which a remainder is 1 when the subcarrier index is divided by 3, which are allocated as subcarriers with signals, and in segment 2, 284 bits are respectively mapped to subcarriers having a subcarrier index of which a remainder is 2 when the subcarrier index is divided by 3, which are allocated as subcarriers with signals.

A preamble subcarrier is modulated as follows:

$$Re \{ PreamblePilotsModulated \} = 4 \cdot \sqrt{2} \cdot ( \frac{1}{2} - {w}_{k} ) \\ Im \{ PreamblePilotsModulated \} = 0 \qquad [ Expression 2 ]$$

Here, a value of Wₖ is determined by table 309 of the Institute of Electrical and Electronics Engineers (IEEE) 802.16e standard.

The MS receives a signal including such a preamble by an antenna. Once the power of the MS is turned on, a receiving unit of the MS performs an initial operation, recovers an operation frequency, and finds a used preamble by a cell search. As mentioned above, a preamble index is identified to decode data.

In general, digital data may be obtained by analog-to-digital conversion on the signal received by the antenna, and then an OFDM symbol may be obtained by performing an initial time and frequency synchronization and removing a cyclic prefix (CP). The FFT is performed on the obtained OFDM symbol to convert the time-domain signal into a frequency domain signal.

In some embodiments, cell search is performed in the time domain before the FFT process. In other embodiments, the cell search is performed in the frequency domain after the FFT process.

The cell search in the time domain is described as follows:

$${C}_{n} = {\sum }_{m = 0}^{1023} {r}_{n - m} \times {P}_{m}^{T} \qquad [ Expression 3 ]$$

Here, Cₙ represents a correlation value between a received signal rₙ in the time domain and time-domain information p^{T}ₘ of the preamble which is already known. The time-domain information p^{T}ₘ is a result of IFFT for frequency domain information p^{F}ₘ (e.g., 1 or −1). The method of performing a cell search in the time domain has problems in that the cell search in the time domain is complicated to implement and consumes a lot of power.

Alternatively, there is a method of performing a cell search in the frequency domain by using a result of an inverse fast Fourier transform (IFFT) after processes in the frequency domain.

The cell search in the frequency domain is described as follows:

dₖ=FFT(rₙ)

sₙ=IFFT(dₖ*Pₖ^{F}) [Expression 4]

Here, the received signal rₙ is a convolution of a channel h and a transmitted signal s (i.e., rₙ=h*s), and thus dₖ, which is a result of FFT for the received signal rₙ, is expressed as a product of a result H of FFT for a time-domain channel h and a result S of FFT for a transmitted time-domain signal s as follows:

dₖ=H*S [Expression 5]

A signal eₖ, which is a product of dₖ and a frequency domain preamble sequence, is expressed as follows:

$${e}_{k} = {d}_{k} * {P}_{m}^{F} \\ = ( H * S ) * {P}_{m}^{F} \\ = ( H * {P}^{F} ) * {P}_{m}^{F} ( since S = {P}_{m}^{F} ) \\ = H \qquad [ Expression 6 ]$$

A result sₙ of IFFT for eₖ is expressed by sₙ=IFFT(H)=h.

Detecting a signal is determined by using a maximum value of the time-domain data. The frequency domain preamble sequence does not need a multiplication since the frequency domain preamble sequence may be 1 or −1. Further, since IFFT may be carried out with a resource for FFT, there is little need for additional resources. The performance of the cell search in the frequency domain may be better than that of the cell search in the time domain.

When multiple antennas are employed, a combination of FFT processes, IFFT processes and IFFT outputs of signals received by the multiple antennas must be considered.

In the above description, the method for performing a cell search in the frequency domain with one antenna is described. When multiple antennas are employed, the complexity of a system increases in proportion to the number of the multiple antennas.

Hereinafter, example embodiments of the present invention will be described on the assumption that multiple antennas, particularly two antennas, are employed.

The above-mentioned preamble is divided into segments. Each segment includes a preamble pilot on every three subcarriers. In case of a segment 0, locations in the frequency domain may be described as in FIG. 3.

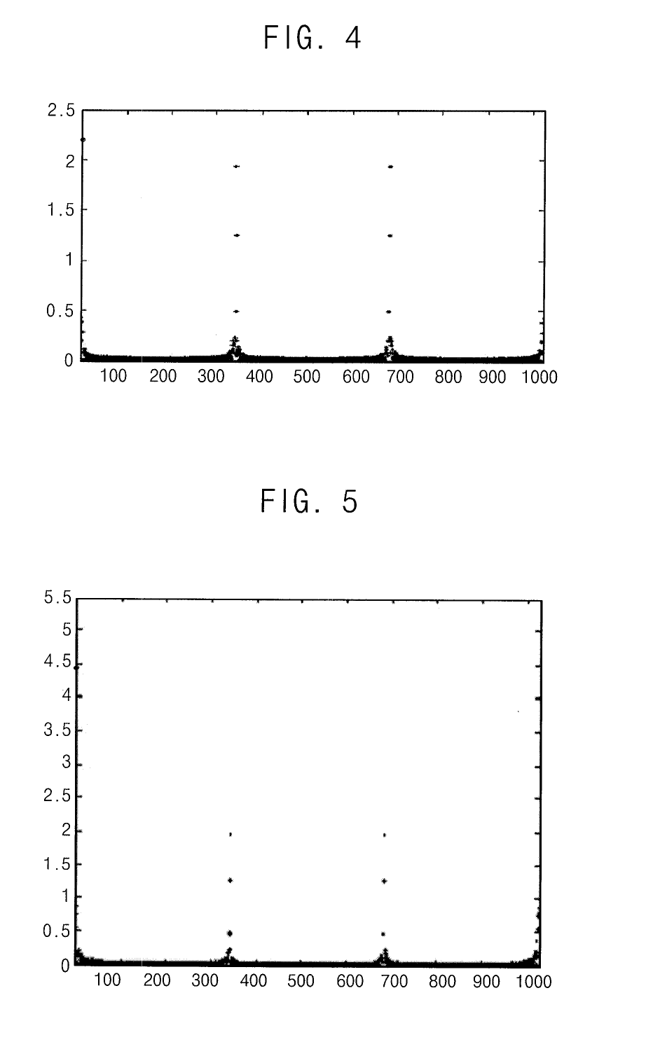

After a preamble of the segment 0 is inverse-randomized into a preamble pilot and the preamble pilot is converted into a time-domain signal, peak values of the time-domain signal are described as in FIG. 4.

Referring to FIG. 4, a horizontal axis represents peak value index numbers, and a vertical axis represents peak value intensity. In FIG. 4, there are peak values at locations of index numbers 1, 342 and 684. In case of the segment 0, all phases at locations of peak values are about 0 degrees.

In case of the segment 1, locations of peak values are the same as those in the segment 0, but phases at locations of peak values are 0 degrees, 120 degrees and 240 degrees, respectively. In case of the segment 2, locations of peak values are the same as those in the segment 0, but phases at locations of peak values are 0 degrees, 240 degrees and 120 degrees, respectively.

Phases at locations of peak values for each segment are described as Table 1.

TABLE 1

| | PHASE | | |
|---|---|---|---|
| | LOCATION | | |
| SEGMENT | 1 | 342 | 684 |
| SEGMENT 0 | 0 | 0 | 0 |
| SEGMENT 1 | 0 | 120 | 240 |
| SEGMENT 2 | 0 | 240 | 120 |

With reference to the above table, the phases at locations of the peak values in a time domain are different according to locations of the subcarriers. Characteristics of each segment may be briefly described as Expression 7.

$${S}_{n}^{0} = {a}_{0} δ ( n - 1 ) + {a}_{1} δ ( n - 342 ) + {a}_{2} δ ( n - 684 ) \\ \begin{matrix}{S}_{n}^{1} = {a}_{0} δ ( n - 1 ) + {a}_{1} exp ( j * π / 3 ) δ ( n - 342 ) + \\ {a}_{2} exp ( j * 2 π / 3 ) δ ( n - 684 )\end{matrix} \\ \begin{matrix}{S}_{n}^{2} = {a}_{0} δ ( n - 1 ) + {a}_{1} exp ( j * 2 π / 3 ) δ ( n - 342 ) + \\ {a}_{2} exp ( j * π / 3 ) δ ( n - 684 ) ,\end{matrix} \\ where \\ δ ( n - k ) = \{ \begin{matrix}1 , & n = k \\ 0 , & n \neq k\end{matrix} \qquad [ Expression 7 ]$$

If a preamble sequence passes through a channel, a phase of the channel is added to the phases according to the segment of the preamble. When two antennas are employed, the combination may utilize that in which the phases of a segment according to locations of the subcarriers in the time domain are different from those of the other segments.

If there is a ‘1’ at locations of the subcarriers of the segment 0 and the segment 1, a combined time-domain signal may be appear as illustrated in FIG. 5.

Referring to FIG. 5, an intensity of the combined time-domain signal at peak value index number 1 increases from about 2.25 to about 4.5, or the intensity of the combined time-domain signal at peak value index number 1 is twice as large as that of the time-domain signal illustrated in FIG. 4 because of the combination. If there is an effect of a channel, the location and intensity of the peak value may be changed.

Characteristics of the combined segments may be expressed as follows:

$$\begin{matrix}{S}_{n}^{Sum} = {a}_{0} δ ( n - 1 ) + {a}_{1} δ ( n - 342 ) + {a}_{2} δ ( n - 684 ) + \\ {a}_{0} δ ( n - 1 ) + {a}_{1} exp ( j * π / 3 ) δ ( n - 342 ) + \\ {a}_{2} exp ( j * 2 π / 3 ) δ ( n - 684 ) \\ = 2 {a}_{0} δ ( n - 1 ) + {a}_{1} exp ( j * π / 6 ) δ ( n - 342 ) + \\ {a}_{2} exp ( j * 5 π / 6 ) δ ( n - 684 )\end{matrix} \qquad [ Expression 8 ]$$

If there are channels h₁ and h₂, the characteristic may be expressed as follows:

$$\begin{matrix}{S}_{n}^{Sum} = {h}_{1} ( \begin{matrix}{a}_{0} δ ( n - 1 ) + {a}_{1} δ ( n - 342 ) + \\ {a}_{2} δ ( n - 684 )\end{matrix} ) + \\ {h}_{2} ( {a}_{0} δ ( n - 1 ) + {a}_{1} exp ( j * π / 3 ) δ ( n - 342 ) + \\ {a}_{2} exp ( j * 2 π / 3 ) δ ( n - 684 ) ) \\ = {a}_{0} ( {h}_{1} + {h}_{2} ) δ ( n - 1 ) + {a}_{1} ( {h}_{1} + {h}_{2} exp ( j * π / 3 ) ) δ ( n - 342 ) + \\ {a}_{2} ( {h}_{1} + {h}_{2} exp ( j * 2 π / 3 ) ) δ ( n - 684 )\end{matrix} \qquad [ Expression 9 ]$$

As described in Expression 9, the location and intensity of the peak value may be changed according to intensities and phases of the channels h₁ and h₂.

One peak value of three peak values a₀(h₁+h₂), a₁(h₁+h₂*exp(j*pi/3)) and a₂(h₁+h₂*exp(j*2pi/3)) may obtain a gain since a vector sum of the other two peak values increases.

Such an increase of the gain may increase a signal-to-noise ratio (SNR) so that quality of communication may be improved.

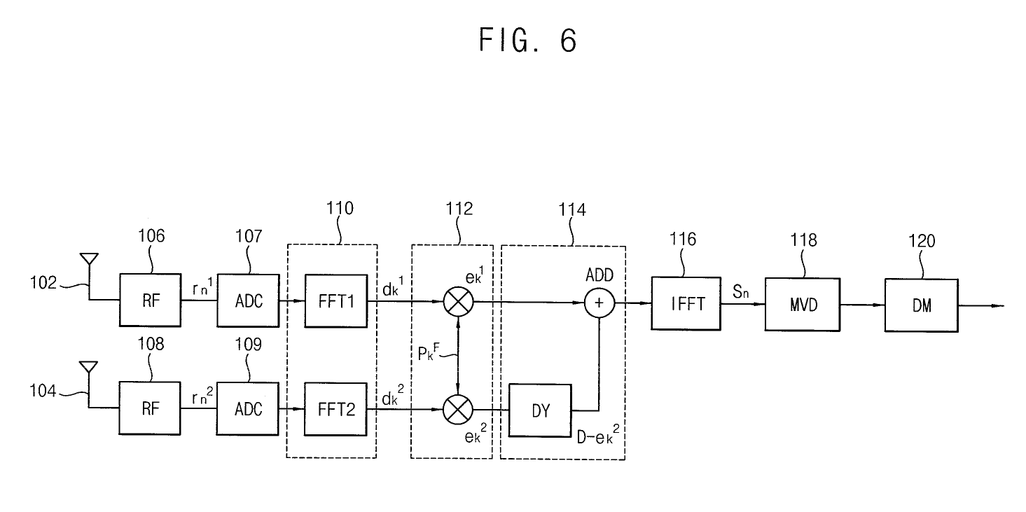

FIG. 6 is a block diagram illustrating an apparatus for performing a cell search according to an example embodiment of the present invention.

Referring to FIG. 6, the apparatus for performing a cell search according to an example embodiment of the present invention includes first and second antennas 102 and 104, first and second high frequency receiving units 106 and 108, first and second analog-to-digital converters (ADCs) 107 and 109, an FFT unit 110, a inverse randomizer 112, an alignment unit 114, an IFFT unit 116, a maximum value detector 118 and a determiner 120.

A signal received by the first antenna 102 is provided to the first ADC 107 as a first received signal rₙ¹ through the first high frequency receiving unit 106. The first ADC 107 converts the first received signal rₙ¹ into a first digital signal, and thus the first digital signal is provided to a first FFT unit (FFT1) of the FFT unit 110. A signal received by the second antenna 104 is provided to the second ADC 109 as a second received signal rₙ² through the second high frequency receiving unit 108. The second ADC 109 converts the second received signal rₙ² into a second digital signal, and thus the second digital signal is provided to a second FFT unit (FFT2) of the FFT unit 110. The inverse randomizer 112 calculates first and second correlation values eₖ¹ and eₖ² by correlating frequency domain signals dₖ¹ and dₖ² converted by FFT1 and FFT2 with preamble frequency domain information p^{F}ₘ of each segment which is already known.

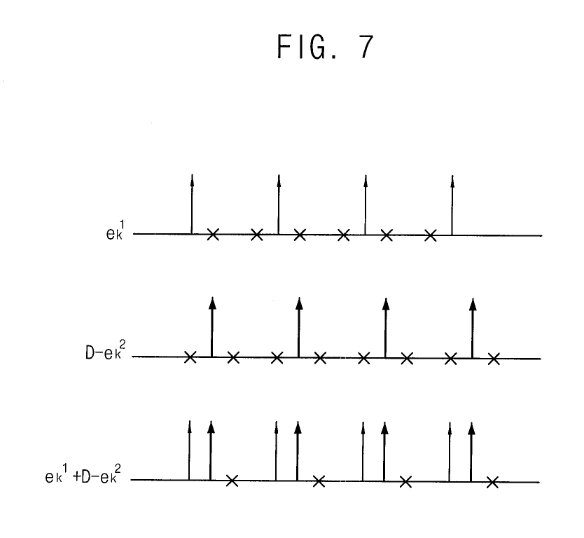

The alignment unit 114 includes a sample delay unit DY and an adder ADD. The sample delay unit DY delays the second correlation value eₖ² by one sample. The adder ADD adds the delayed correlation value D-eₖ² to the first correlation value eₖ¹. As illustrated in FIG. 7, the added value is aligned such that subcarriers with signals of a segment 1 are aligned with subcarriers with signals of a segment 0. The aligned signal is converted into a time-domain signal Sₙ by the one IFFT unit 116.

The maximum value detector 118 detects a maximum value of the converted time-domain signal Sₙ. The determiner 120 determines whether a preamble of a specific cell and a specific segment exists in response to the detected maximum value.

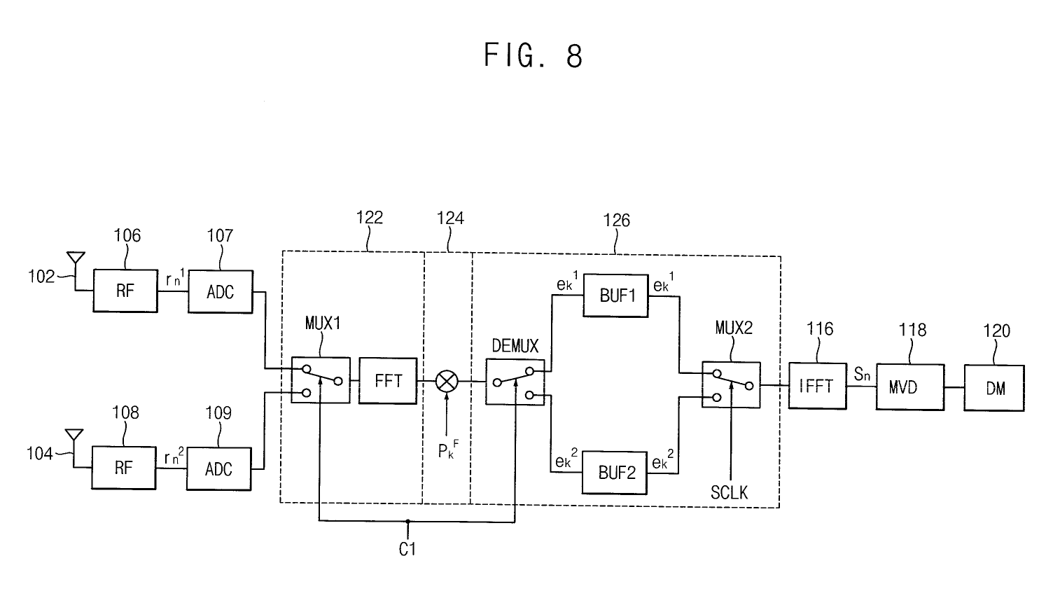

FIG. 8 is a block diagram illustrating an apparatus for performing a cell search according to another example embodiment of the present invention.

Referring to FIG. 8, the apparatus for performing a cell search according to another example embodiment of the present invention includes first and second antennas 102 and 104, first and second high frequency receiving units 106 and 108, first and second ADCs 107 and 109, an FFT unit 122, a inverse randomizer 124, an alignment unit 126, an IFFT unit 116, a maximum value detector 118 and a determiner 120. Unlike the apparatus for performing a cell search according to an example embodiment illustrated in FIG. 6, the apparatus for performing a cell search according to another example embodiment illustrated in FIG. 8 is implemented such that two FFT blocks are employed.

The FFT unit 122 includes a selector MUX1 and an FFT unit. The selector MUX1 selectively couples received signals rₙ¹ and rₙ² to the FFT unit in response to an antenna selection signal C1.

The inverse randomizer 124 generates a correlation value by correlating a frequency domain signal provided by the FFT unit with preamble frequency domain information p^{F}ₘ of each segment which is already known.

The alignment unit 126 includes an input selector DEMUX, first and second buffers BUF1 and BUF2 and an output selector MUX2.

The input selector DEMUX distributes first and second correlation values eₖ¹ and eₖ² to the first and second buffers BUF1 and BUF2 in response to the antenna selection signal C1. The first buffer BUF1 stores the first correlation value eₖ¹ related to a first antenna 102, and the second buffer BUF2 stores the second correlation value eₖ² related to a second antenna 104. The output selector MUX2 selects outputs of the buffers BUF1 and BUF2 one after the other in response to an alignment control signal SCLK so that an output signal of the output selector MUX2 is aligned as in FIG. 7. That is, the alignment control signal SCLK is activated during one sample period after one sample period when the first correlation value eₖ¹ is selected.

This invention has been described with reference to the example embodiments. It is evident, however, that many alternative modifications and variations will be apparent to those having skill in the art in light of the foregoing description. Accordingly, the present invention embraces all such alternative modifications and variations as falling within the spirit and scope of the appended claims.

For example, when three antennas are employed, a signal received by a third antenna may be delayed by one sample with respect to a signal received by a second antenna, or in order, such that subcarriers with signals of segment 2 related to the third antenna are aligned with locations of subcarriers without signals of segment 0 related to a first antenna that are located at a distance of two samples with respect to subcarriers with signals of the segment 0.

### INDUSTRIAL APPLICABILITY

As described above, an apparatus and a method for performing a cell search according to some example embodiments of the present invention combine signals received by a plurality of antennas and convert the combined signal into a time-domain signal by one inverse fast Fourier transform (IFFT) unit. Therefore, a signal gain is enhanced by the combination so that communication quality and performance may be improved and the complexity of a configuration of a terminal may be reduced.

This invention has been described with reference to the example embodiments. It is evident, however, that many alternative modifications and variations will be apparent to those having skill in the art in light of the foregoing description. Accordingly, the present invention embraces all such alternative modifications and variations as falling within the spirit and scope of the appended claims.

1. An apparatus for performing a cell search in a wireless communication terminal device employing multiple antennas and complying with the Institute of Electrical and Electronics Engineers (IEEE) 802.16d/e standard, comprising:
a plurality of fast Fourier transform (FFT) units configured to convert a plurality of signals respectively received by the multiple antennas into a plurality of frequency domain signals by FFT;
a plurality of inverse randomizers configured to inverse-randomize the plurality of the frequency domain signals generated by the plurality of the FFT units, respectively;
a delay unit configured to delay an output of an inverse randomizer of the plurality of the inverse randomizers by a predetermined sample;
an adder configured to add an output of the delay unit to an output of another inverse randomizer of the plurality of the inverse randomizers;
an inverse fast Fourier transform (IFFT) unit configured to convert an output of the adder into a time-domain signal by IFFT;
a maximum value detector configured to detect a maximum value of the time-domain signal; and
a determiner configured to determine whether a preamble is obtained based on the maximum value detected by the maximum value detector.

2. A method for performing a cell search in a wireless communication terminal device employing multiple antennas and complying with the IEEE 802.16d/e standard, comprising:
converting a plurality of signals respectively received by the multiple antennas into a plurality of frequency domain signals by FFT;
inverse-randomizing the plurality of the frequency domain signals;
delaying an inverse-randomized signal of the plurality of the inverse-randomized frequency domain signals by a predetermined sample;
adding the delayed signal to the plurality of the inverse-randomized frequency domain signals;
converting the delayed signal into a time-domain signal by IFFT;
detecting a maximum value of the time-domain signal; and
determining whether a preamble is obtained based on the detected maximum value.

3. An apparatus for performing a cell search in a wireless communication terminal device employing multiple antennas and a multiple access scheme, comprising:
a plurality of FFT units configured to convert a plurality of signals respectively received by the multiple antennas into a plurality of frequency domain signals by FFT;
a plurality of inverse randomizers configured to inverse-randomize the plurality of the frequency domain signals generated by the plurality of the FFT units, respectively;
an alignment unit configured to align the plurality of the inverse-randomized frequency domain signals to form an aligned signal;
an IFFT unit configured to convert the aligned signal into a time-domain signal by IFFT;
a maximum value detector configured to detect a maximum value of the time-domain signals; and
a determiner configured to determine whether a preamble is obtained based on the maximum value detected by the maximum value detector.

4. The apparatus of claim 1, wherein the alignment unit is configured to form the aligned signal by aligning the plurality of the inverse-randomized frequency domain signals such that subcarriers with signals of at least one of the plurality of the inverse-randomized frequency domain signals are located at locations of subcarriers without signals of another inverse-randomized frequency domain signal of the plurality of the inverse-randomized frequency domain signals.

5. The apparatus of claim 4, wherein the alignment unit comprises:
a delay unit configured to delay the at least one of the plurality of the inverse-randomized frequency domain signals by a predetermined sample in order; and
an adder configured to add the at least one of the plurality of the inverse-randomized frequency domain signals that have been successively delayed to the other inverse-randomized frequency domain signal of the plurality of the inverse-randomized frequency domain signals and configured to output an addition result as the aligned signal.

6. A method for performing a cell search in a wireless communication terminal device employing multiple antennas and a multiple access scheme, comprising:
converting a plurality of signals respectively received by the multiple antennas into a plurality of frequency domain signals by FFT;
inverse-randomizing the plurality of the frequency domain signals;
aligning the plurality of the inverse-randomized frequency domain signals to form an aligned signal;
converting the aligned signal into a time-domain signal by IFFT;
detecting a maximum value of the time-domain signals; and
determining whether a preamble is obtained based on the detected maximum value.

7. The method of claim 6, wherein aligning the plurality of the inverse-randomized frequency domain signals includes aligning the plurality of the inverse-randomized frequency domain signals such that subcarriers with signals of at least one of the plurality of the inverse-randomized frequency domain signals are located at locations of subcarriers without signals of another inverse-randomized frequency domain signal of the plurality of the inverse-randomized frequency domain signals.

8. The method of claim 7, wherein aligning the plurality of the inverse-randomized frequency domain signals comprises:
delaying the at least one of the plurality of the inverse-randomized frequency domain signals by a predetermined sample in order; and
adding the at least one of the plurality of the inverse-randomized frequency domain signals that have been successively delayed to the other inverse-randomized frequency domain signal of the plurality of the inverse-randomized frequency domain signals and configured to output an addition result as the aligned signal.

9. A method for performing a cell search in a wireless communication terminal, comprising:
generating a first frequency domain signal by fast-Fourier-transforming a signal received by a first antenna;
generating a second frequency domain signal by fast-Fourier-transforming a signal received by a second antenna;
inverse-randomizing the first and the second frequency domain signals;
aligning the first and the second frequency domain signals to form an aligned signal, such that subcarriers with signals of the second frequency domain signal are located at locations of subcarriers without signals of the first frequency domain signal;
generating a time-domain signal by inverse-fast-Fourier-transforming the aligned signal; and
determining a preamble index in response to a maximum value of the time-domain signal.

10. An apparatus for performing a cell search in a wireless communication terminal device employing multiple antennas and a multiple access scheme, comprising:
an FFT unit configured to convert a plurality of signals respectively received by the multiple antennas into a frequency domain signal by FFT in response to an antenna selection signal;
an inverse randomizer configured to inverse-randomize the frequency domain signal generated by the FFT unit;
an alignment unit configured to buffer the inverse-randomized frequency domain signal in response to the antenna selection signal such that the buffered signals corresponds to the multiple antennas, respectively, and configured to align the buffered signals to form an aligned signal;
an IFFT unit configured to convert the aligned signal into a time-domain signal by IFFT;
a maximum value detector configured to detect a maximum value of the time-domain signal; and
a determiner configured to determine whether a preamble is obtained based on the maximum value detected by the maximum value detector.

11. The apparatus of claim 10, wherein the alignment unit is configured to form the aligned signal by aligning the plurality of the inverse-randomized frequency domain signals such that subcarriers with signals of at least one of the plurality of the inverse-randomized frequency domain signals are located at locations of subcarriers without signals of another inverse-randomized frequency domain signal of the plurality of the inverse-randomized frequency domain signals.

12. The apparatus of claim 11, wherein the alignment unit comprises:
an input selector configured to distribute the inverse-randomized frequency domain signal in response to the antenna selection signal such that the distributed frequency domain signals correspond to the multiple antennas;
a plurality of buffers coupled to the input selector and configured to store the distributed frequency domain signals corresponding to the multiple antennas, respectively; and
an output selector configured to switch the signals respectively stored in the plurality of the buffers in order in response to an alignment control signal and configured to generate the aligned signal.

13. A method for performing a cell search in a wireless communication terminal device employing multiple antennas and a multiple access scheme, comprising:
converting a plurality of signals respectively received by the multiple antennas into frequency domain signals by FFT;
inverse-randomizing the frequency domain signals;
aligning the inverse-randomized frequency domain signals to form an aligned signal;
converting the aligned signal into a time-domain signal by IFFT;
detecting a maximum value of the time-domain signal; and
determining whether a preamble is obtained based on the detected maximum value.

14. The method of claim 13, wherein aligning the plurality of the inverse-randomized frequency domain signals is aligning the plurality of the inverse-randomized frequency domain signals such that subcarriers with signals of at least one of the plurality of the inverse-randomized frequency domain signals are located at locations of subcarriers without signals of another inverse-randomized frequency domain signal of the plurality of the inverse-randomized frequency domain signals.

15. The method of claim 14, wherein aligning the plurality of the inverse-randomized frequency domain signals comprises:
separately storing the plurality of the inverse-randomized frequency domain signals such that the plurality of the separately stored frequency domain signals correspond to the multiple antennas, respectively; and
aligning the plurality of the separately stored frequency domain signals such that subcarriers with signals of at least one of the plurality of the separately stored frequency domain signals are located at locations of subcarriers without signals of another separately stored frequency domain signal of the plurality of the separately stored frequency domain signals.

16. A method for performing a cell search in a wireless communication terminal device, comprising:
multiplexing signals received by first and second antennas in response to an antenna selection signal;
generating a frequency domain signal by fast-Fourier-transforming the multiplexed signal;
inverse-randomizing the frequency domain signal;
storing de-multiplexed signals by de-multiplexing the inverse-randomized frequency domain signal in response to the antenna selection signal;
outputting an aligned signal where subcarriers with signals of at least one of the stored de-multiplexed signals are located at locations of subcarriers without signals of another stored de-multiplexed signal of the stored de-multiplexed signals.
generating a time-domain signal by inverse-fast-Fourier-transforming the aligned signal; and
determining a preamble index in response to a maximum value of the time-domain signal.
